(19) United States
(12) Patent Application Publication
(10) Pub. No.: US 2012/0211975 A1
(43) Pub. Date: Aug. 23, 2012

(54) END FITTING FOR A FLEXIBLE RISER AND METHOD OF ASSEMBLY

(75) Inventors: George Carneiro CAMPELLO, Rio de Janeiro (BR); Marcos Carpigiani De Almeida, Rio de Janeiro (BR)

(73) Assignee: PETRÓLEO BRASILEIRO S.A. - PETROBRAS, Rio de Janeiro (BR)

(21) Appl. No.: 13/402,629

(22) Filed: Feb. 22, 2012

(30) Foreign Application Priority Data
Feb. 22, 2011 (BR) PI 1100148-8

(51) Int. Cl. F16L 33/01; B32B 37/02; B32B 37/14; F16L 33/18

(52) U.S. Cl. 285/222.2; 285/222.1; 156/92

(57) ABSTRACT

The present invention relates to an end fitting of a flexible riser. The device makes it possible to carry out the assembly procedure without the need to bend the tensile armour. By means of the assembly procedure thereof, the technique proposed eliminates residual tension due to plastic deformation of the tensile armour and modifications in the microstructural properties of the steel, imposed by current end fittings and the corresponding techniques for assembling the same.

### CROSS REFERENCE TO RELATED APPLICATIONS

This application claims priority to BR PI 1100148-8, filed 22 Feb. 2011, the entire contents of which, including specification, claims and drawings, are hereby incorporated by reference.

### FIELD OF THE INVENTION

The present invention relates to an end fitting for flexible risers. The device enables the assembly procedure to be carried out with no need to bend the tensile armour. The assembly procedure in the present invention eliminates the residual tensions produced due to plastic deformation of the tensile armour and also the modifications in microstructural properties of the steel, imposed by common end fittings and their respective assembly techniques.

### BASIS OF THE INVENTION

In offshore production systems, crude oil produced in wells on the ocean floor is conveyed to a stationary production unit (SPU) by means of pipelines. These pipelines of electro-hydraulic umbilicals for injecting water and for pumping oil and gas are commonly referred to as collection and production lines.

This set of pipelines constituting the collection and production lines is basically subdivided into two distinct parts:
The first portion, preponderantly horizontal, denominated: the horizontal segment. This portion is conventionally static and also specifically known in the technical terminology as “flowline”.
The second portion, constituted by a preponderantly vertical pipe connected to the extremity of the horizontal segment and which ascends from the sea floor to the platform whereat it is connected, denominated: the vertical segment. The second portion is also known, and hereinafter denominated, by the technical terminology of “riser”

The term vertical as used here should not be interpreted in the strict sense, since the distance between the platform and the point of connection to the “flowline”, together with the weight of the riser itself, means that this stretch has to take a substantially curved shape known as catenary.

There are basically two types of riser on the market: rigid and flexible, which are fixed to a platform by means of supporting structures specially designed to support and to resist the stresses applied therein, which can be due to the weight thereof as well as movement thereof due to ocean currents, for example.

Like the supporting structures, the end fitting must also be designed to support and to resist the stress from weight and movement of the riser.

### RELATED ART

Adopting the system of flexible risers adds several more difficulties, due to the need for solutions related to anchorage, because flexible risers, due to their construction, are more sensitive than rigid risers to the various different stresses to which they are submitted.

These flexible risers are constituted by superimposing at least six interdependent layers with totally different compositions: the first, innermost layer is the inner casing, followed by a polymeric pressure layer. These are followed by the pressure armour, the inner layer of tensile armour, and the outer layer of tensile armour, comprising braided steel wire. All of the foregoing are further covered with an outer polymer layer.

Currently, to fix the upper end of a flexible riser to the corresponding support in the SPU, the end of the riser has to be fixed to a device, which serves as the engaging and supporting means between the riser as such and the support. This device is known in the art as the “end fitting”.

This results in a situation in which the stresses due to the weight and movement of a riser are concentrated in a single region. This region is represented by three components of a collection and production line, namely: the support, the end fitting and the free end of the flexible riser.

The three components interact differently with each other. While the support shows restricted freedom of movement with respect to the corresponding end fitting, the end fitting itself can only interact in a fixed manner with respect to the six components that form the flexible riser.

As regards this aspect of fixing, the end fittings are designed and manufactured so as to offer the best means for uniting the components for supporting the flexible riser and at the same time they also offer reliable means for hydraulic insulation as regards the inner polymeric pressure layer. Currently, this union is basically obtained as follows:
First the inner and outer layers of the tensile armour, which are made of steel and confer axial strength to resist the tensile stresses to which the flexible riser is submitted, are exposed.
In order to achieve transfer of the tensile stresses from the riser to the end fitting, and then to the support on the platform, adhesion of the wire of the tensile armour is promoted by a resin in a section inside the end fitting. This adhesion is carried out inside the end fitting, in the vicinity of the opening, known in the art as the wedge region or canula.

This is a critical region due to the change of geometry imposed on the steel wire of tensile armour. The current assembly procedure used to bend the wire in the opening region of the end fitting requires the plastic deformation of the tensile armour.

According to the practice currently adopted, the internal sealing and anchoring of the armour are carried out in the same region of the end fitting, which necessarily entails bending of the tensile armour in order to access the inner sealing layer in order to subsequently seal the same.

Over the years, those skilled in the art have noted that most of the problems related to flexible risers occur precisely in the vicinity of the end fitting, which is the critical region of the structure where the tensile stresses on the collection and production line are greatest.

Experience of dissection of end fittings for risers which have been in operation, or which have been subjected to evaluation tests, show that there is a critical section as regards faults in risers inside the end fitting, and this is precisely the section in which the tensile armour undergoes plastic deformation during the process of assembling the end fittings.

The existence of a section predominantly associated with failure is principally because, although the flexible riser undergoes rigid quality control during manufacture, the end fitting is assembled manually by an assembler in the factory or on board a ship.

As currently designed by the manufacturers, in the process of assembling an end fitting the assembler needs to bend (“pull away”) the wire of the tensile armour so as to be able to reach the layers further inside the pipe and seal the inner layer, and then bond the steel wire, both in the same region of the end fitting.

This forcible bending of the wire of the tensile armour causes plastic deformation of the steel of the wire, inducing considerable residual tension in the armour. Plastic deformation and the geometrical discontinuities caused by reassembling the armour to inject the resin occur precisely in the section of the armour of which most is demanded: close to the opening of the end fitting, at the beginning of the resin region, where this whole process of bending and unbending the tensile armour, together with the concentration of tension that occurs in this region, accelerates the process of fatigue in the wire.

The problems outlined above are described in various documents in the specialist technical literature. Document U.S. Pat. No. 6,273,142, published 14, Aug. 2001, relates to a flexible pipe with an end fitting; document U.S. Pat. No. 6,923,477, published 02, Aug. 2005, relates to a terminal end fitting for multilayer flexible pipes with an internal seal; and document U.S. Pat. No. 6,592,153, published 15, Jul. 2003, describes a terminal end fitting for flexible pipes; document PI 0704349-2, published 05, May 2009, relates to an end fitting for flexible pipes; and document PI 0703202-1, published 28, Apr. 2009, relates to a terminal for a flexible riser with a conical fitting. These are all examples of the various different models of end fittings currently on the market, which invariably require that the steel armour layer be bended in order to carry out the appropriate internal sealing and to complete the assembly thereof.

The present invention has been developed for carrying out assembly of the flexible riser at the end fitting without submitting the tensile armour to plastic deformation.

To this end we have developed an end fitting for the flexible riser and the method of assembly without deforming the armour, which is the object of the present invention, the aim of which is to simplify the assembly procedure, to improve the precision of adhesion between the end fitting and the riser, to eliminate residual plastic tension, and also to maintain the original geometry of the wire armour of the flexible risers in the vicinity of the opening of the end fitting.

It also aims to provide a novel concept of connection, which can be adopted as the base for new designs.

Other objectives which the end fitting for the flexible riser and method of assembly without deforming the armour, which are the object of the present invention, are intended to achieve are enumerated below:
1. to enable an increase in the service life of the ends of flexible risers;
2. to make it possible to use flexible risers in deeper waters;
3. to simplify considerably the assembly procedure;
4. to improve significantly the structural performance of the flexible riser especially as regards increasing its fatigue life.

### SUMMARY OF THE INVENTION

In a first aspect, the invention pertains to an end fitting for the flexible riser constituted by three distinct parts, namely: a core, an outer casing, and a termination.

The core is composed of a predominantly cylindrical piece provided at one of its ends with a main flange, with the other end thereof having a conical shape. The conical end has a diameter large enough for the core, when directed against the riser, to fit between the pressure armour and the two superimposed layers of tensile armour of said riser. The main flange, at the end of the core, is provided with an inner chamfer which accommodates a frontal seal ring in the form of a wedge, with an activation flange superimposed thereon.

A supporting flange is provided close to the main flange of said core, so as to be able to shield the free ends of the two superimposed layers of tensile armour within the limit of the inside diameter of a cylindrical outer casing.

The outer casing comprises a substantially cylindrical piece which has a constant outside diameter, with one end thereof fixed to the main flange, the size of which is equivalent to the inside diameter thereof. The free end of the cylindrical outer casing is provided with an inner chamfer which accommodates a rear seal ring in the form of a wedge, also with an activation flange superimposed thereon. Inside, between the cylindrical outer casing and the conical portion of the core, a chamber is formed, which is filled with resin.

Finally, the termination is fixed to the main flange of the core.

In a second aspect, the invention pertains to a method to ensure that the device is assembled on the risers, without deforming the tensile armour of the same, by following basically the following steps:
cutting the outer covering of a riser so that the layers of tensile armour are exposed for a length sufficient for anchoring the same;
positioning the core of the end fitting under the layers of tensile armour;
fitting the free ends of the layers of tensile armour; into the supporting flange so that they are shielded on the body of the core, and within the limit of the inside diameter of a cylindrical outer casing;
fixing the cylindrical outer casing to the core;
securing the outer covering by fitting a first activation flange;
sealing and securing the inner sealing layer, by fitting a second activation flange;
fixing the termination to the main flange of the core;
filling resin into the chamber where the tensile armour is anchored to the body of the end fitting.

### BRIEF DESCRIPTION OF THE DRAWINGS

The invention will be described below in more detail together with the drawings discussed below which, solely as examples, accompany the present report, of which they are an integral part, and in which:

FIG. 1 is a cross-sectional view of an end fitting of the prior art.

FIG. 2 is a cross-sectional view of the end fitting of the present invention.

FIG. 3 is a cross-sectional view of an alternative embodiment of the present invention.

### DETAILED DESCRIPTION OF THE INVENTION

The end fitting for a flexible riser and method of assembly without deforming the armour, which are the object of the present invention, have been developed from studies primarily intended to eliminate residual tensions and modification of the microstructural properties of steel caused during the current procedure for connecting the end fitting and the tensile armour of a flexible riser.

The present invention provides means for altering the assembly procedure in relation to that currently employed, eliminating the need to bend the wire of the armour.

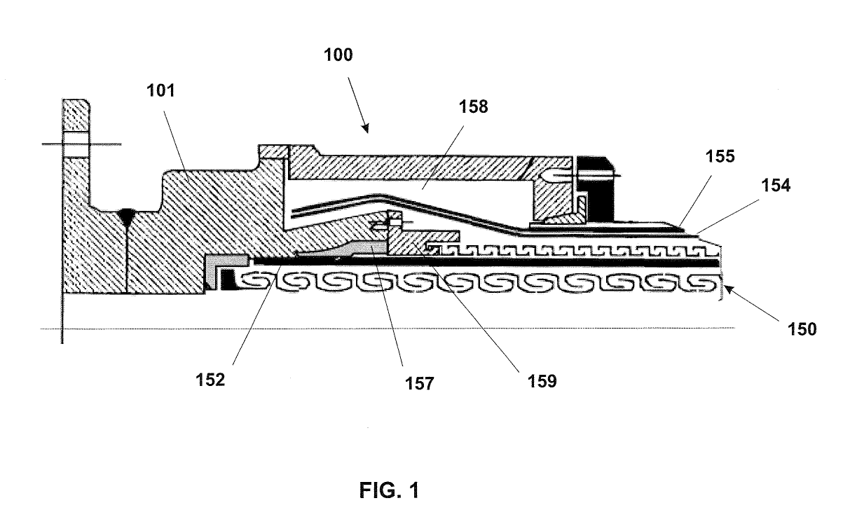

As can be seen from FIG. 1 this shows in schematic cross-section how the six basic layers of a riser (150) are fixed by adhesion to a standard type of end fitting (100), in accordance with the prior art.

In one way or another the end fittings (100) in the prior art always show a main termination (101) in which the polymeric pressure layer (152) is sealed by the inner seal ring (157) and the anterior seal activation flange (159). The inner (154) and outer (155) layer of armour of the riser (150) are adhered by means of the resin in the chamber (158), the opening of which is close to and directed in the same sense as the body of said main termination (101).

Thus, this standard structure entails bending backwards the layers of tensile armour (154) and (155), usually known as the wire of the tensile armour, during the assembly procedure, so that the assembler can reach the polymeric pressure layer (152) and position the inner seal ring (157) and then fix the anterior seal activation flange (159). Subsequently, the layers of tensile armour (154) and (155) are unbent, so that these can be adhered inside the chamber (158), by injecting resin, in the outermost section of the riser (150).

The end fitting (200) for a flexible riser and method of assembly without deforming the armour, proposed herein, have been developed from the basic configuration of the end fittings (100) currently on the market, but use a novel approach of fitting the riser (150).

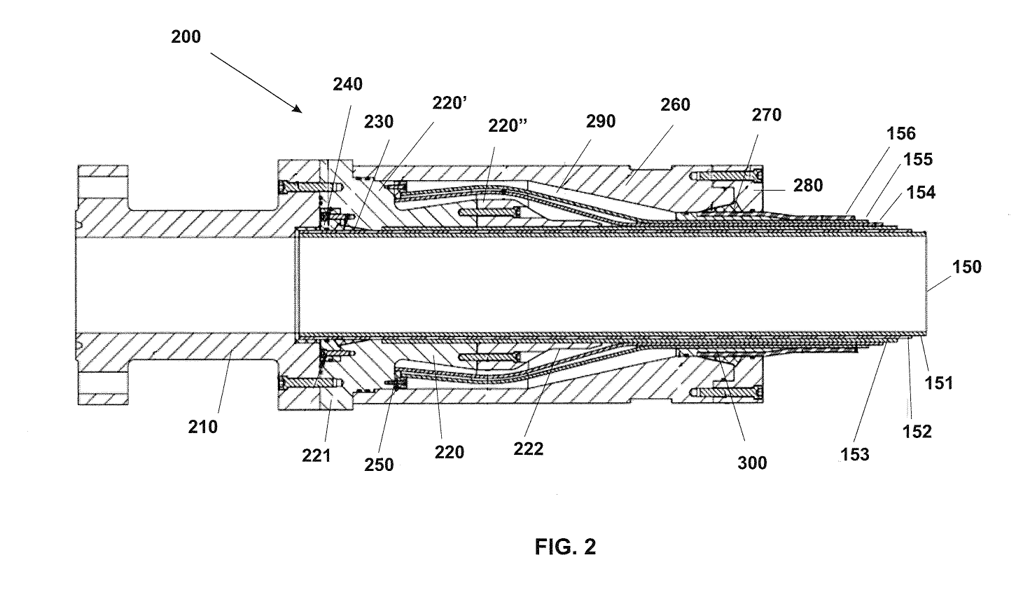

As can be seen in FIG. 2, in this novel inventive concept, the main body of the end fitting (200) is constituted by three distinct parts, namely: a termination (210), a core (220), and an outer casing (260).

As will be shown below, and can be readily visualized with the aid of the figures, this novel structural concept enables the assembler to adhere the inner polymeric pressure layer (152) without the need to change the direction of the layers of tensile armour (154) and (155) of the riser (150) by bending, because the sealing zone of the inner polymeric pressure layer (152) and the zone of adhesion and anchoring of the tensile armour (154) and (155) are located in different, independent, points in the end fitting (200).

The core (220) is constituted by a predominantly cylindrical piece provided with a flange (221) at one of the ends thereof and having a conical shape at the other end (222) thereof.

The conical end (222) has a diameter sufficient for said core (220), when directed against the riser (150), to fit between the pressure armour (153) of said riser (150) and the two superimposed layers (154) and (155) of the tensile armour.

The flange (221) at the end of the core (220) is provided with an internal chamfer, which accommodates a frontal seal ring (230) in the form of a wedge, overlaid by a first activation flange (240). When pressed by the first activation flange (240), said frontal seal ring (230) in the form of a wedge squeezes the polymeric pressure layer (152) forming an internal seal.

Optionally in order to facilitate manufacture, the core (220) can be made up of two independent pieces, fitted together by some fitting means; one of these, the anterior core (220′), being constituted by a section provided with the flange (221), and the other, the posterior core (220″), being constituted by a section provided with a wedge-shaped conical end (222).

A support flange (250) is provided close to the flange (221) of said core, so as to be able to support the free ends of the two superimposed layers (154) and (155) of tensile armour within the limit of the inside diameter of a cylindrical outer casing (260).

The cylindrical outer casing (260) has a constant outside diameter and one of the ends thereof is fixed to the flange (221), which has a size equivalent to the inside diameter thereof. Inside, the diameter of the cylindrical outer casing (260) is constant from the end thereof fixed to said flange (221) to close to the beginning of the conical portion of the core (220), when the diameter starts to get smaller, following the conical shape of said portion of the core, but being longer, until the inside diameter reaches the outer covering (156) of the riser (150).

The outer covering (156) of the riser (150) is shielded and separated from the other layers of the riser (150) by an expansion ring (300), which is placed between said outer covering (156) and the superimposed layers of tensile armour (154) and (155).

The free end of the cylindrical outer casing (260) has an internal chamfer, which accommodates a posterior seal ring (270) in the form of a wedge, overlaid by a second activation flange (280), which, when pressed against the free end of said cylindrical outer casing (260), causes the posterior seal ring (270) to squeeze the outer covering (156) of the riser (150) against the expansion ring (300).

Inside, between the cylindrical outer casing (260) and the conical portion of the core (220) a chamber (290) is formed, which is filled with epoxy resin or the like, resulting in sustaining adhesion between the end fitting (200) and the superimposed layers of tensile armour (154) and (155). This zone of adhesion occurs in a portion in which the tensile armour (154) and (155) is not subject to any type of plastic deformation or change in the composition of the strands thereof or even the angle with respect to the axis of the riser (150).

Finally, the termination (210) is fixed to the flange (221) of the core (220), to give the final configuration of the end fitting (200).

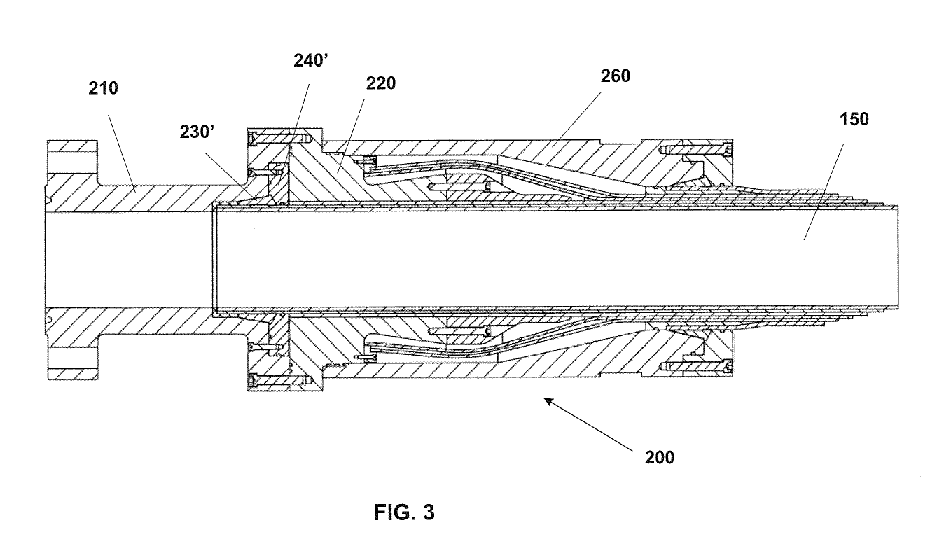

Other proposals for effecting the inner or outer seal can be presented without deviating from the inventive concept, such as, for example, the alternative embodiment presented in FIG. 3, in which the inner seal is effected by a seal ring (230′) and an activation flange (240′) which act against the body of the termination (210).

The invention also pertains to a rapid method of assembly without needing to bend the layers of tensile armour of the riser.

The method will be described with reference to FIG. 2, but it should be emphasized that the inventive concept described below is not restrictive, and a person skilled in the art will recognize that it is possible to alter the sequence in order to include or eliminate certain steps of the method to suit new configurations of the basic end fitting (200) shown both in FIG. 2 and in FIG. 3, these alterations being included within the scope of the method of the invention.

With the help of FIG. 2 it is possible to see the procedure for initiating the assembly of the riser (150), following the following steps:

1—Cutting the outer covering (156) of the riser (150) so that the layers of tensile armour (154) and (155) are exposed for a length sufficient for anchoring the same;

2—Placing an expansion ring (300) under the outer covering (156);

3—Positioning the core (220) of the end fitting under the layers of tensile armour (154) and (155);

4—Fixing the support flange (250) of the wire, preferably by means of screws, to the flange (221) of the core;

5—Fitting the free ends of the layers of tensile armour (154) and (155) into the support flange (250) so that they are shielded on the body of the core (220), and within the limit of the inside diameter of a cylindrical outer casing (260);

6—Fixing the cylindrical outer casing (260) to the core (220), preferably by a screw thread, but which can also be by means of a flange;

7—Positioning the posterior seal ring (270) in the form of a wedge behind the cylindrical outer casing (260), and then securing the outer covering (156), by means of fitting an activation flange (280);

8—Positioning the frontal seal ring (230) on the polymeric pressure layer (152), in the form of a wedge and sealing and securing said layer (152), by fitting an activation flange (240), preferably by means of screws, to the top of the flange (221) of the core (220);

9—Fixing the termination (210) to the flange (221) of the core (220), preferably by means of screws;

10—Filling with resin the chamber (290), where the tensile armour (154) and (155) is anchored to the body of the end fitting (200).

Alternatively, this last step can be carried out shortly after the seventh step.

It can be easily appreciated that the current invention not only eliminates the need to bend the tensile armour of the riser, but more especially it also makes the assembly procedure much more simple and rapid.

However, one of the main factors which makes the present proposal feasible is not limited to ease of assembly, but above all to eliminating residual plastic tension left during assembly using available end fittings according to the prior art.

Thus, one of the unquestionable advantages of the proposed invention is, therefore, to raise the reliability of the connection and establish new parameters for operational stresses in flexible risers, in order to ensure lower levels of failure.

The invention has been described here with reference to preferred embodiments thereof. However, it should be clear that the invention is not restricted to these embodiments, and those skilled in the art will immediately perceive which alterations and substitutions can be adopted without deviating from the inventive concept described herein.

1- End fitting for a flexible riser for linking Stationary Production Units (SPUs) to oil wells, characterized in that said end fitting (200) for a flexible riser includes a termination (210), a core (220) and an outer casing (260) wherein:
the core (220) is constituted by a predominantly cylindrical piece provided in one of the ends thereof with a flange (221) and a support flange (250) with the other end thereof (222) having a conical shape;
the conical end (222) has a diameter sufficient for said core (220), when directed against the riser (150), to fit between the pressure armour (153) of said riser (150) and the two superimposed layers of tensile armour (154) and (155);
the flange (221) at the end of the core (220) is provided with an internal chamfer, which accommodates a frontal seal ring (230) in the form of a wedge, with an activation flange (240) superimposed thereon;
the support flange (250) is provided close to the flange (221) of said core, so as to be able to shield the free ends of the two superimposed layers of tensile armour (154) and (155) within the limit of the inside diameter of a cylindrical outer casing (260);
the cylindrical outer casing (260) has a constant external diameter, with one of the ends thereof fixed to the flange (221) the size of which is equivalent to the internal diameter thereof; inside, the diameter of the cylindrical outer casing (260) is constant from the end thereof fixed to said flange (221) to close to the beginning of the conical portion of the core (220) when the diameter gets smaller in parallel with the conical shape of said portion of the core, but being longer, until the inside diameter reaches the outer covering (156) of the riser (150);
an expansion ring (300) to shield and separate the outer covering (156) of the riser (150) of the superimposed layers of tensile armour (154) and (155);
the free end of the cylindrical outer casing (260) is provided with an internal chamfer, which accommodates a posterior seal ring (270) in the form of a wedge, with a second activation flange (280) superimposed thereon;
inside, between the cylindrical outer casing (260) and the conical portion of the core (220), a chamber (290) is formed, which is filled with resin; and
the termination (210) is fixed to the flange (221) of the core (220).

2- fitting for a flexible riser according to claim 1, characterized in that the zone of sealing of the inner polymeric pressure layer (152) and the zone of adhesion and anchoring of the tensile armour (154) and (155) are situated at different and independent points in the end fitting (200).

3- fitting for a flexible riser according to claim 1, characterized in that the inner seal can alternatively be effected by a seal ring (230′) and an activation flange (240′) which act against the body of the termination (210).

4- fitting for a flexible riser according to claim 1, characterized in that alternatively the core (220) is constituted by two independent members fitted together by some fitting means, with one of the pieces being the anterior core (220′), constituted by a section provided with the flange (221) and the other piece, the posterior core (220″), constituted by a section provided with a conical wedge shaped end (222).

5- fitting for a flexible riser according to claim 1, characterized in that the zone of adhesion is in a portion in which the tensile armour (154) and (155) is not subject to any type of plastic deformation or alteration in the composition of its strands.

6- fitting for a flexible riser according to claim 1, characterized in that the zone of adhesion is in a portion in which the strands of the tensile armour (154) and (155) are not subject to any type of alteration of angle relative to the axis of the riser (150).

7- fitting for a flexible riser according to claim 1, characterized in that the zone of adhesion is in a portion in which the tensile armour (154) and (155) is not subject to modifications in the microstructural properties of the steel.

8- Method of assembly without deforming the armour of the end fitting for a flexible riser according to claim 1, characterized in that it includes the following steps:
1) cutting the outer covering (156) of the riser (150) so that the layers of tensile armour (154) and (155) are exposed for a length sufficient for anchoring the same;
2) placing an expansion ring (300) under the outer covering (156);
3) positioning the core (220) of the end fitting under the layers of tensile armour (154) and (155);
4) fixing the support flange (250) of the wire, preferably by means of screws, to the flange (221) of the core;
5) fitting the free ends of the layers of tensile armour (154) and (155) into the support flange (250), such that they are shielded on the body of the core (220), and within the limit of the inside diameter of a cylindrical outer casing (260);
6) fixing the cylindrical outer casing (260) to the core (220);
7) positioning the posterior seal ring (270) in the form of a wedge behind the cylindrical outer casing (260), and then securing the outer covering (156), by fitting a second activation flange (280);
8) positioning the frontal seal ring (230) in the form of a wedge on the polymeric pressure layer (152), and then sealing and securing said layer (152), by fitting the first activation flange (240);
9) fitting the termination (210) to the flange (221) of the core (220);
10) filling with resin the chamber (290), where the tensile armour (154) and (155) is already positioned.

9- Method of assembly without deforming the armour of the end fitting for a flexible riser, according to claim 8, characterized in that alternatively, the tenth and last step can be carried out soon after the seventh step.

10- Method of assembly without deforming the armour of the end fitting for a flexible riser, according to claim 8, characterized in that the cylindrical outer casing (260) is fixed to the core (220) preferably by means of a screw thread.

11- Method of assembly without deforming the armour of the end fitting for a flexible riser, according to claim 8, characterized in that the cylindrical outer casing (260) is fixed to the core (220) by means of a flange.

12- Method of assembly without deforming the armour of the end fitting for a flexible riser, according to claim 8, characterized in that the frontal seal ring (230) in the form of a wedge is positioned on the polymeric pressure layer (152) and that sealing and securing of said layer (152) is effected by fitting the first activation flange (240), preferably by means of screws, to the top of the flange (221) of the core (220).

13- Method of assembly without deforming the armour of the end fitting for a flexible riser, according to claim 8, characterized in that the termination (210) is fixed to the flange (221) of the core (220), preferably by means of screws.
